(19) United States
(12) Patent Application Publication
(10) Pub. No.: US 2020/0051320 A1
(43) Pub. Date: Feb. 13, 2020

(54) METHODS, DEVICES AND SYSTEMS FOR FOCUS ADJUSTMENT OF DISPLAYS

(71) Applicant: Lemnis Technologies Pte. Ltd., Singapore (SG)

(72) Inventors: Pierre-Yves LAFFONT, Singapore (SG); Ali HASNAIN, Singapore (SG)

(21) Appl. No.: 16/484,737

(22) PCT Filed: Feb. 12, 2018
(86) PCT No.: PCT/SG2018/050064

§ 371 Date: Aug. 8, 2019

(30) Foreign Application Priority Data
May 10, 2017 (SG) 10201703839W
Jul. 29, 2017 (SG) 10201706193W
Aug. 13, 2017 (SG) 10201706606U
Dec. 12, 2017 (SG) 10201701107P
Jan. 8, 2018 (SG) 10201800191W

(51) Int. Cl. G06T 15/20; G06F 3/01; G06T 15/06; G06T 5/00; G06F 1/16; G02B 7/04

(52) U.S. Cl. CPC G06T 15/20; G06F 3/013; G02B 7/04; G06T 5/002; G06F 1/163; G06T 15/06

(57) ABSTRACT

Methods, systems and devices and computer readable medium are provided for viewing a virtual environment through of an optical system. The method includes determining a focus of the optical system configured to view the virtual environment and reconfiguring the optical system for viewing the virtual environment in response to the determining of the focus of the optical system. The method may further include modifying a rendering of the virtual environment in response to the reconfiguring of the optical system. Determining the focus of the optical system may determine at least one gaze direction of the user when using the optical system to view the virtual environment and determining at least one point in the virtual environment corresponding to the gaze direction of the user.

### PRIORITY CLAIMS

The present application claims priority to Singapore patent application numbers 10201701107P filed on 12 Feb. 2017, 10201703839W filed on 10 May 2017, 10201706193W filed on 29 Jul. 2017, 10201706606U filed on 13 Aug. 2017 and 10201800191W filed on 8 Jan. 2018.

### FIELD OF INVENTION

The following disclosure relates to methods, devices and systems for adjusting focus of displays and in particular to the use of the same in near-eye displays or head-mounted displays.

### BACKGROUND

Current generation of Virtual Reality (VR) Head-Mounted Displays (HMDs) comprise a stereoscopic display, which presents a distinct image to the left and right eye of the user. The disparity between these images produces vergence eye movements which provide a sense of depth to the user, who may then perceive the virtual environment in three dimensions.

Known commercial head-mounted displays are focused at a fixed distance during normal use, and do not require the user's eyes to accommodate. This is not consistent with real-world vision and results in conflict between accommodation and vergence: the vergence cues inform the user of the depth of each observed region, which may vary depending on the gaze direction, whereas the accommodation cues conflictingly indicate that every region is at a constant depth. Many studies suggest that this vergence-accommodation conflict contributes to distorted depth perception, and to visual fatigue and discomfort, especially when using such displays over extended periods.

In order to improve the VR user experience and reduce the discomfort experienced by many users, it is necessary to overcome the conflict between vergence and accommodation cues. What is needed is the ability to provide HMD users with realistic accommodation cues, which are consistent with the vergence cues and the depth of the observed region of the virtual environment.

Existing vari-focal approaches adjust the focal distance of single plane displays based on the eye fixation point, but suffer from a low field of view when using electronically tunable lenses. Light-field displays sample projections of the virtual scene at different depths or light rays across multiple directions, but face significant resolution, refresh rate, and/or computational challenges. Furthermore, most of the known methods assume the viewer's eyes are aligned with the display system (e.g., on the optical axis of a lens) and do not handle deviations from those positions.

In addition, most commercial VR headsets available today are designed for users with perfect eyesight, and are uncomfortable or impossible to wear for users with eyeglasses. While manual adjustments of focus and inter-pupillary distance (IPD) are possible on some models, it is generally performed by the user through a trial-and-error approach. Such manual adjustments may not accurately correct the user's eyesight, and may even worsen visual discomfort and depth perception in some cases.

There is thus a need for technical solutions to provide virtual reality, augmented reality, mixed reality and digital reality methods, devices and systems to dynamically adjust focus and to correct distortions created by dynamically adjusting the focus for enabling a sharp and comfortable viewing experience and correcting eye refraction errors with or without eyeglasses. In addition, there is a need for technical solutions to provide methods and devices for robust eye tracking in a varifocal optical system. Furthermore, other desirable features and characteristics will become apparent from the subsequent detailed description and the appended claims, taken in conjunction with the accompanying drawings and this background of the disclosure.

### SUMMARY

In accordance with one aspect of present embodiments, a method, a system and a device for viewing a virtual environment through an optical system is provided. The method includes determining a focus of the optical system configured to view the virtual environment and reconfiguring the optical system for viewing the virtual environment in response to the determining of the focus of the optical system. The method may further include modifying a rendering of the virtual environment in response to the reconfiguring of the optical system. The the step of determining the focus of the optical system to view the virtual environment may include determining at least one gaze direction of the user when using the optical system to view the virtual environment and determining at least one point in the virtual environment corresponding to the gaze direction of the user. The method may further include receiving an input, the input being information including at least one of a characteristic of the user's eyesight, an eyeglasses prescription of the user, eyesight information of the user, demographic information of the user or a state of an eye condition of the user and determining the focus of the optical system may be performed in response to the received input. Determining the focus of the optical system may include determining a focus of the optical system configured to view the virtual environment in response to a clarity of a viewing of the virtual environment. Determining the focus of the optical system may also include determining a focus of the optical system configured to view the virtual environment in response to a comfort level of the user and modifying the rendering of the virtual environment may include modifying the rendering of the virtual environment in response to the reconfiguring of the optical system in order that a size, a position and/or distortion of a perceived image of the virtual environment remains unchanged before and after the reconfiguration of the optical system.

The perceived image may include an image perceived from at least one specific position, the image including one or more of an image perceived by an eye of the user, a computer-generated simulation, or an image or video captured by a camera and the computer-generated simulation may use data from a simulated eye model or from a simulated camera to generate the image perceived from the specific position or the computer-generated simulation may use raytracing to generate the image perceived from the specific position.

Modifying the rendering of the virtual environment may also include modifying a rendering of the virtual environment in response to the reconfiguring of the optical system in order to make the retinal image created by a viewing of the virtual environment through the optical system substantially similar to a retinal image that would be created if the virtual environment was observed in the real world or may include modifying the virtual environment in response to the reconfiguring of the optical system using computer-implemented depth-of-field blur to create depth-of-field blur in one or more regions of the perceived image of the virtual environment or may include modifying the virtual environment in response to the reconfiguring of the optical system using computer simulations of eye models which take into account characteristics of the eye of the user. The characteristics of the eye of the user may include myopia, hyperopia, presbyopia or astigmatism. The virtual environment may further be modified in response to the reconfiguring of the optical system using computer simulations of eye models which take into account chromatic aberrations in the eye of the user or the rendering of the virtual environment may be performed in response to the received input.

At least one of the steps of determining the focus of the optical system or reconfiguring the optical system or modifying the rendering of the virtual environment may be performed in response to receiving at least one of a position of one of the user's eyes, a position of the user, a direction of the user's gaze or a characteristic of the user's eyes, the characteristic of the user's eyes including a distance between the user's eyes. In addition, the step of reconfiguring the optical system may include adjusting at least one of a focal length of the optical system, a position of the optical system, a position of a display on which the virtual environment is rendered or a distance of the optical system relative to the display on which the virtual environment is rendered and an accommodating response may be induced in at least one of the user's eyes. Further, the virtual environment may include one of a virtual reality environment, an augmented reality environment, a mixed reality environment or a digital reality environment.

The system for viewing a virtual environment may include a display, an optical system through which a user can view a rendering of the virtual environment on the display, and a processing means coupled to the optical system and the display, the processing means determining a focus of the optical system and instructing the optical system to reconfigure in response to the determination of the focus of the optical system. The system may further include an eye tracking means for tracking at least one eye of a user viewing the rendering of the virtual environment on the display, wherein the eye tracking means is coupled to the processing means, and wherein the processing means determines at least one gaze direction of the eye of the user when using the optical system to view the virtual environment in response to information received from the eye tracking means, and wherein the processing means further determines at least one point in the virtual environment corresponding to the gaze direction of the user in response to the information received from the eye tracking means. The optical system may include a reconfigurable varifocal optical system and a controller for adjusting the reconfigurable varifocal optical system in response to the processing means instructing the optical system to reconfigure and the controller may include a piezoelectric device, a resonator device coupled to the piezoelectric device, and a driven element, the driven element coupled to the resonator device and a lens element of the reconfigurable varifocal optical system, wherein the piezoelectric device generates micro-level vibrations at a tip of the resonator to move the driven element, thereby moving the lens element in a curvature. The device for viewing the virtual environment on a display, the device may include the optical system through which a user can view a rendering of the virtual environment on the display, and a processing means coupled to the optical system, the processing means determining a focus of the optical system and instructing the optical system to reconfigure in response to the determination of the focus of the optical system.

In accordance with another aspect of present embodiments, a system for viewing a virtual environment includes a display and a processing means, the processing means providing information to the display for rendering the viewed virtual environment, the information provided to the display modifying a rendering of the virtual environment displayed thereon to compensate for a reconfiguration of an optical system through which the display is viewed in order that a size, a position and distortion of a perceived image of the virtual environment remains substantially same after the reconfiguration of the optical system, the perceived image including an image perceived from a specific position. The image includes one or more of an image perceived by an eye of the user, a computer-generated simulation generated by the processing means, or an image captured by a camera. The computer-generated simulation uses eye modeling or data from the camera to generate the image perceived from the specific position or uses raytracing to generate the image perceived from the specific position.

In accordance with another aspect of present embodiments, a system includes a display and a processing means, the processing means providing information to the display for rendering the viewed virtual environment, wherein the information provided to the display modifies a rendering of the virtual environment to compensate for a reconfiguration of an optical system through which the display is viewed in order to create a retinal image of a perceived image of the virtual environment substantially similar to a retinal image of the perceived image of the virtual environment that would be observed in an eye of the user if the virtual environment was observed in the real world. The processing means modifies the virtual environment using computer-implemented depth-of-field blur to create depth-of-field blur in one or more regions of the perceived image of the virtual environment or using computer simulations of eye models which take into account chromatic aberrations in the eye of the user.

In accordance with another aspect of present embodiments, a method for rendering a virtual environment includes reconfiguring an optical system through which the virtual environment is viewed and modifying the rendering of the virtual environment to compensate for the reconfiguration of the optical system in order that a size, a position and/or distortion of a perceived image within the virtual environment remains substantially same before and after the reconfiguration of the optical system, the perceived image comprising an image perceived from a specific position, the image including one or more of an image perceived by an eye of the user, a computer-generated simulation, or an image or video captured by a camera where the computer-generated simulation uses eye modeling or data from the camera or raytracing to generate the image perceived from the specific position. Alternatively, the method modifies the rendering of the virtual environment to compensate for the reconfiguration of the optical system in order to create a retinal image of a perceived image of the virtual environment substantially similar to a retinal image of the perceived image of the virtual environment that would be observed in an eye of the user if the virtual environment was observed in the real world. The virtual environment may be modified in response to the reconfiguring of the optical system using computer-implemented depth-of-field blur to create depth-of-field blur in one or more regions of the perceived image of the virtual environment or may be modified using computer simulations of eye models which take into account chromatic aberrations in the eye of the user.

In accordance with yet another aspect of the present embodiments, a device for modifying a view of a user a display system includes a lens system including one or more Alvarez or Alvarez-like lens elements, each of the one or more Alvarez or Alvarez-like lens elements including two or more lenses and a controller coupled to the lens system for moving at least two of the two or more lenses in respect to one another for correcting the view of the user in response to a command to modify a virtual image on a display of the display system. The controller moves the at least two of the two or more lenses laterally over one another in a specific direction to generate either a positive spherical power change or a negative spherical power change for correcting the view of the user in response to a refractive error condition of the eye of the user, the refractive error condition of the eye of the user including myopia, hyperopia or presbyopia, or in response to a refocusing request. Alternatively, the controller moves the at least two of the two or more lenses laterally over one another in a specific direction to generate either a positive spherical power change or a negative spherical power for dynamic refocusing of the view of the user to resolve a vergence-accommodation conflict or to respond to a refocusing request or moves the at least two of the two or more lenses laterally over one another in a specific direction to generate a positive cylindrical power change or a negative cylindrical power to change the view of the user in response to an astigmatism condition of the eye of the user or in response to a refocusing request. Additionally, the controller moves at least two of the two or more lenses of at least two of the one or more Alvarez or Alvarez-like lens elements over one another in a clockwise direction or a counter-clockwise direction to change a cylinder axis of the at least two of the one or more Alvarez or Alvarez-like lens elements for changing the view of the user in response to an astigmatism condition of an eye of the user or in response to a refocusing request.

The lens system may further include at least one additional lens, and the one or more Alvarez or Alvarez-like lens elements may be located between the eye of the user and the at least one additional lens or may be located between the at least one additional lens and the display or one of the one or more Alvarez or Alvarez-like lens elements may be located between the eye of the user and the at least one additional lens and another one of the one or more Alvarez or Alvarez-like lens elements may be located between the at least one additional lens and the display. The controller may move the at least two of the two or more lens elements separately or simultaneously.

In accordance with a further aspect of the present embodiments, a device for modifying a user's view of a display includes an eye tracking system comprising a camera directed towards an eye of the user to capture at least one image of the eye of the user, a processing means coupled to the eye tracking system for receiving the at least one image and correcting distortions in the at least one image to generate at least one distortion corrected image of the eye of the user, the processing means further determining parameters of viewing by the eye of the user in response to the at least one distortion corrected image of the eye of the user, and a varifocal optical system coupled to the processing means and located between the camera of the eye tracking system and the eye of the user, the varifocal optical system modifying the view of the user in response to the parameters of the viewing by the eye of the user, wherein the varifocal optical system is located between the eye of the user and the camera, the parameters of the viewing comprising at least a direction of gaze of the eye of the user. The eye tracking system determines the parameters of the viewing by the eye of the user in response to a current size and/or position of a cornea or an iris or a pupil of the eye of the user as captured by the camera. The camera is an infrared camera and the eye tracking system further includes infrared lighting devices for lighting the eye of the user with infrared light, the infrared lighting devices being independently switchable on or off substantially simultaneously with capture of the at least one image by the camera.

In accordance with a further aspect of the present embodiments, a device for modifying a view of a user Includes an eye tracking system comprising a camera focused on an eye of the user, a varifocal optical system for modifying the view of the user, and a controller coupled to the eye tracking system and the varifocal optical system for estimating a type of eye movement of the eye of the user in response to information from the eye tracking system, the type of eye movement comprising at least one or more of a fixation, a saccade or a smooth pursuit, wherein the controller adjusts a focus of the varifocal optical system in response to the estimated type of eye movement. The controller estimates a desired focus distance of the varifocal optical system or a desired velocity of the change of focus distance of the varifocal optical system in response to the information from the eye tracking system and adjusts the focus of the varifocal optical system in response to the desired focus distance and/or desired velocity of the change of focus distance of the varifocal optical system. When the type of eye movement is a saccade, the controller sets the focus of the varifocal optical system to a distance corresponding to an observed distance predicted by the controller at the end of a saccade and when the type of eye movement is a smooth pursuit, the controller continuously adjusts the focus of the varifocal optical system smoothly during the smooth pursuit in accordance with a velocity profile estimated by the controller in response to one or more of information from the eye tracking system and/or information on characteristics of the eye of the user. The characteristics of the eye of the user include myopia, hyperopia, presbyopia or astigmatism.

In accordance with a final aspect of present embodiments, a method includes modifying a rendering of a virtual environment in order to create a retinal image of a perceived image of the virtual environment substantially similar to a retinal image of the perceived image of the virtual environment that would be observed in an eye of the user if the virtual environment was observed in the real world. The virtual environment may be modified using computer-implemented depth-of-field blur to create depth-of-field blur in one or more regions of the perceived image of the virtual environment or using computer simulations of eye models which take into account chromatic aberrations in the eye of the user.

### BRIEF DESCRIPTION OF THE DRAWINGS

Embodiments of the invention will be better understood and readily apparent to one of ordinary skilled in the art from the following written description, by way of example only, and in conjunction with the drawings, in which:

FIG. 1A is a high level schematic view 100 of a prior art device for virtual reality, augmented reality, mixed reality and digital reality.

FIG. 1B is a high level illustration of embodiments of the present invention.

FIG. 2A shows a flowchart depicting a method for viewing a virtual environment through an optical system, in accordance with an embodiment of the present invention.

FIG. 2B shows a flowchart depicting a method for viewing a virtual environment through an optical system, in accordance with another embodiment of the present invention.

FIG. 3A shows a flowchart depicting a method for adjusting the focus of a display system, in accordance with an embodiment of the present invention.

FIG. 3B shows a flowchart depicting a method for adjusting the content shown on a display according to a focus adjustment of a display system, in accordance with an embodiment of the present invention.

FIG. 3C shows a flowchart depicting a method for adjusting the content shown on a display according to a focus adjustment of a display system, such that the size and position of the image perceived from a specific position remain substantially the same after focus adjustment, in accordance with an embodiment of the present invention.

FIG. 3D shows a flowchart depicting a method for adjusting the focus of a display system and adjusting the content shown on said display according to the characteristics of a user, in accordance with an embodiment of the present invention.

FIG. 3E shows a flowchart depicting a method for adjusting the focus of a display system and adjusting the content shown on said display according to the characteristics of a user and visual content displayed, in accordance with an embodiment of the present invention.

FIG. 4 illustrates optical magnification of a lens.

FIG. 5 shows a schematic of an embodiment of the invention which constitutes a focus-adjustable stereoscopic display system, including two adjustable eyepieces which can adjust the focus independently for each eye.

FIG. 6 shows photographs of a front view and a back view of an embodiment of the invention embodied in a Head-Mounted Display (HMD) device.

FIG. 7 shows a schematic diagram of a focus adjustable stereoscopic display system integrated with an eye tracking system in accordance with an embodiment of the present application.

FIG. 8 shows a schematic diagram of a focus adjustable stereoscopic display system integrated with an eye tracking system in accordance with another embodiment of the present application.

FIG. 9 shows a schematic diagram of a focus adjustable stereoscopic display system integrated with an eye tracking system in accordance with yet another embodiment of the present application

FIG. 10 illustrates a schematic of a system for viewing a virtual environment through an optical system, which depicts how different parts of the system interact with each other.

FIG. 11 shows a photograph of an embodiment of a head-mounted display (HMD) embedded with an eye tracker and dynamic refocusing in accordance with an embodiment of the present application, wherein eye tracking cameras are embedded at the bottom of the HMD to track user's monocular or binocular gaze.

FIG. 12 shows photographs of multiple views of the HMD as shown in FIG. 11.

FIG. 13 shows an embodiment in which the HMD as shown in FIG. 9 is integrated with a hand tracking device.

FIG. 14 shows a photograph of the right eye of a user captured by an endoscopic Infrared (IR) camera embedded in the nose bridge of the HMD, in accordance with another embodiment of the present application.

FIG. 15 shows a schematic of an embodiment of a dynamic refocusing mechanism in which a pair of Alvarez or Alvarez-like lenses are dynamically actuated and moved to achieve desired focusing power and/or vision correction.

FIG. 16 shows dioptric changes achieved using the dynamic refocusing mechanism as shown in FIG. 15.

FIG. 17 shows an embodiment in which the dynamic refocusing mechanism is implemented into a VR headset.

FIG. 18 shows different movements of Alvarez or Alvarez-like lens elements to create spherical power, to create cylindrical power, or to change cylinder axis, in accordance with various embodiments of the present application.

### DETAILED DESCRIPTION

Embodiments of the present invention will be described, by way of example only, with reference to the drawings. Like reference numerals and characters in the drawings refer to like elements or equivalents. It is appreciated by those skilled in the art that the methods, devices and systems described herein are applicable to either one eye or both eyes of a user.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions in regards to a computer system or similar electronic devices utilizing terms such as “determining”, “reconfiguring”, “modifying”, “receiving”, “rendering”, “compensating”, “adjusting”, “inducing” or the like, refer to the action and processes that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

One goal of several embodiments is to make a user's eye accommodate when viewing through a display system by creating focus cues. The goal seeks to create retinal images similar to those what would be perceived in the real world. Embodiments of the present application, as described and illustrated herein, include:
a method, device and system for adjusting the focus of a display system;
a method, device and system for adjusting the content shown on a display according to a focus adjustment of a display system;
a method, device and system for adjusting the content shown on a display according to a focus adjustment of a display system, such that the size and position of the image perceived from a specific position remain substantially the same after focus adjustment. Perceived images include images captured by a camera placed at the specific position. The captured images remain substantially similar in size and position when observed from a specific position. Advantageously, a user whose eye is located at the specific position will not perceive a substantial variation in the image before said user's eye starts accommodating as a result of the focus change.
a method, device and system for making focal adjustments according to the characteristics of a user;
a method, device and system for making such adjustments according to the characteristics of a user and visual content displayed;
a method, device and system for robust eye tracking for varifocal optical systems;
a system which includes a display system into a head-mounted display (HMD), which may include a system to track the users' eyes; and
computer-implemented applications of the methods above for i) providing accommodation cues consistent with vergence cues in stereoscopic display systems, ii) correcting the users' vision without prescription eyeglasses, iii) automatically adjusting display systems, iv) using adjustable focus display systems in HMDs for Virtual Reality, Augmented Reality, Mixed Reality, Digital Reality, or the like, and/or v) tracking the user's gaze during the use of such HMDs, or the like.

The above mentioned various embodiments, when working in conjunction, provides a method for viewing a virtual environment through an optical system that can advantageously provide accommodation cues consistent with vergence cues in stereoscopic display systems, correct users' vision without prescription eyeglasses, automatically adjust display systems, use adjustable focus display systems in HMDs for Virtual Reality, Augmented Reality, Mixed Reality, Digital Reality, or the like, and/or track the user's gaze during the use of such HMDs. In various embodiments, the present methods combine the dioptric adjustment of optical systems with the modification of images shown on displays, and may take into account the position and gaze direction of users and the visual content shown on the display.

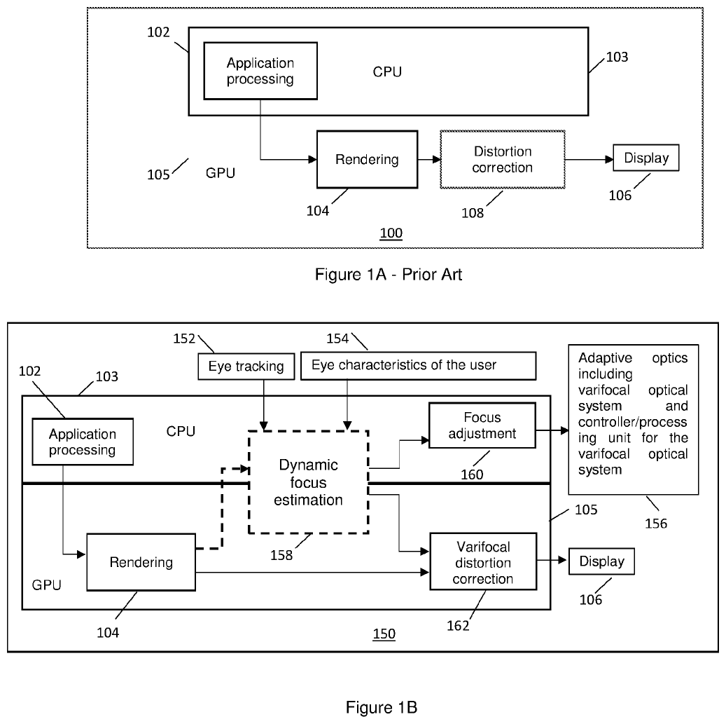

FIG. 1A is a high level schematic view 100 of a prior art device for virtual reality, augmented reality, mixed reality and digital reality. For conventional virtual reality devices, information for creation of a virtual environment is generated by an application processing module 102 in a central processing unit 103 (CPU) of a computing device. In order to generate a virtual environment visible by a user, the information from the application processing module 102 is provided to a rendering module 104 in a graphical processing unit 105 (GPU) for rendering of display information to be provided to a display 106 whereon the virtual environment can be viewed by the user. A distortion correction module 108 can modify information from the rendering module 104 in a predetermined manner to correct for distortions known to appear in the virtual environment. This prior art device has a fixed-focus optical system that is not adapting or changing the focus according to the virtual environment displayed on the display 106, any changes due to movement of the user, a change in the focus of the virtual environment, or characteristics of a user's eye. Thus prior art devices for creation and viewing of virtual environments such as that shown in FIG. 1A provide an uncomfortable viewing experience and can neither provide a sharp and comfortable view of the virtual environment where multiple objects are located at different distances, nor correct for eye refraction errors.

FIG. 1B is a high level illustration 150 of embodiments of the present invention. In accordance with present embodiments, a robust system for rendering a virtual reality environment includes both hardware and software elements which work together to provide a sharp and comfortable viewing experience where multiple objects are located at different distances and correct a user's eye refraction errors regardless of whether the user is wearing eyeglasses when viewing the virtual environment.

The hardware elements include the display 106, an eye tracking device 152 for tracking movement of the user's eye including size and movement of portions of the eye such as the cornea and/or the iris, an input device 154 which can receive eye characteristics of the user, and adaptive optics 156 which includes at least a varifocal optical system and at least a controller/processing unit for adjusting the varifocal optical system. Many additions, variations or substitutions of the hardware elements can be made within the spirit of the present embodiments.

The software elements include a dynamic focus estimation module 158, a focus adjustment module 160 and a varifocal distortion correction module 162. The dynamic focus estimation module 158 is software which can reside solely within the CPU 103 or partially within the CPU 103 and partially within the GPU 105 (as depicted in the illustration 150). Likewise, the varifocal distortion correction module 162 can reside solely within the CPU 103, solely within the GPU 105 (as depicted in the illustration 150), or partially within the CPU 103 and partially within the GPU 105. In response to information from the eye tracking device 152 and/or the input device 154, the dynamic focus estimation module 158 during operation generates instructions for controlling the focus adjustment module 160 and the varifocal distortion correction module 162. The dynamic focus estimation module 158 can also receive information from the rendering module 104 for generation of the instructions to the focus adjustment module 160 and the varifocal distortion correction module 162 as indicated by the dashed arrow. In some embodiments, the information from the eye tracking device 152 can be directly received by the varifocal distortion correction module 162 as an additional input for controlling the varifocal distortion correction module 162 to modify the information provided from the rendering module 104 thereby modifying the virtual environment on the display 106.

In one aspect, when the dynamic focus estimation module 158 determines a focus of the varifocal optical system to configure the adaptive optics 156 to view the virtual environment, the dynamic focus estimation module 158 modifies a rendering of the virtual environment in response to reconfiguring the adaptive optics 156 by providing instructions to the varifocal distortion correction module 162 to modify the information provided from the rendering module 104 thereby modifying the virtual environment on the display 106.

In another aspect, the dynamic focus estimation module uses images captured by at least one eye tracking cameras and/or at least one rendering or depth map of the virtual environment from the eye tracking device 152 to estimate the type of eye movement, which may be a fixation, a saccade, or a smooth pursuit, to predict a desired focus distance of the display optical system or a desired velocity of the desired focus distance of the display optical system. The dynamic focus estimation module 158 then instructs the focus adjustment module 160 to generate and provide signals to the adaptive optics 156 to adjust focus of the varifocal optical system in accordance with the estimated eye movement, such as by setting the focus to the distance corresponding to the predicted observed distance at the end of a saccade, or by continuously adjusting the focus during a finite period in case of a smooth pursuit. The dynamic focus estimation module 158 also generates an appropriate velocity profile for the focal adjustment. In addition, the dynamic focus estimation module 158 may send a new instruction to focus adjustment module 160 to generate and send signals to the adaptive optics 156 when the eye movement changes, which triggers an interruption in the focal adjustment and signals the adaptive optics 156 to follow the new instructions immediately. Advantageously, this process enables both a smooth focus transition during a smooth pursuit eye movement and a rapid change of focus in the case of an eye saccade. Further aspects of present embodiments will be described in more detail hereinbelow.

It will be appreciated by those skilled in the art that in the following described methods and the corresponding illustrated flow diagrams, while the steps are presented sequentially, some or all of these steps will be performed in parallel.

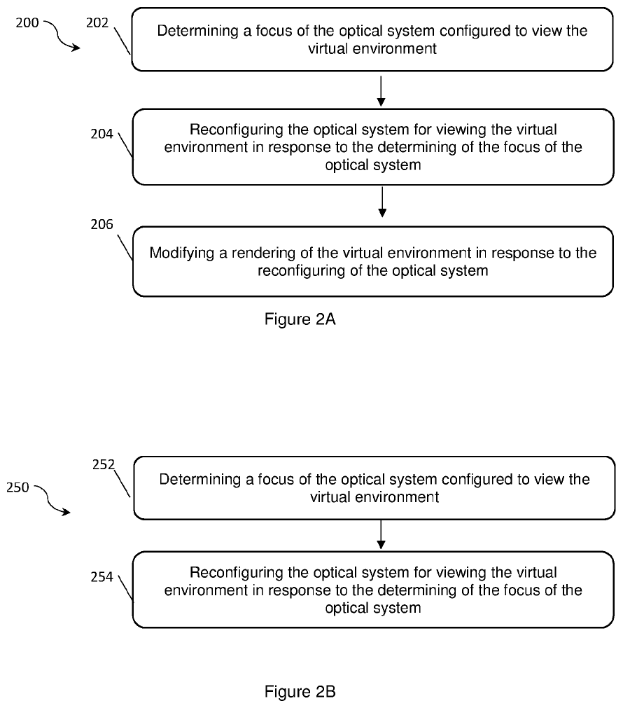

FIG. 2A shows a flow diagram 200 of a method for viewing a virtual environment through an optical system according to a first embodiment. The method 200 comprises steps including:
Step 202: determining a focus of the optical system configured to view the virtual environment;
Step 204: reconfiguring the optical system for viewing the virtual environment in response to the determining of the focus of the optical system; and
Step 206: modifying a rendering of the virtual environment in response to the reconfiguring of the optical system.

In the present application, steps 202, 204 and 206 are implemented in the form of focus adjustment of a display system, focus adjustment depending on content and user, and image adjustment on the display, and can be used in stereoscopic displays and HMDs.

Similarly, FIG. 2B shows a flow diagram 250 of a method for viewing a virtual environment through an optical system according to a second embodiment.

The method 200 comprises steps including:
Step 252: determining a focus of the optical system configured to view the virtual environment; and
Step 254: reconfiguring the optical system for viewing the virtual environment in response to the determining of the focus of the optical system.

Steps 252 and 254 are implemented in the form of focus adjustment of a display system and focus adjustment depending on content and user, and can be used in stereoscopic displays and HMDs.

### Focus Adjustment of a Display System

In accordance with an embodiment of the present application, there is provided a method for adjusting the focus of a display system comprising: at least one mechanism or a controller/processing unit or a combination of both for obtaining the desired position of a virtual image; at least one electronic display; and at least one reconfigurable optical system configured to dynamically adapt, such that the virtual image of said electronic display appears to be at the desired location when viewed through said optical system. It will be appreciated by those skilled in the art that the virtual image refers to an apparent position of the physical display when observed through optical elements of the optical system.

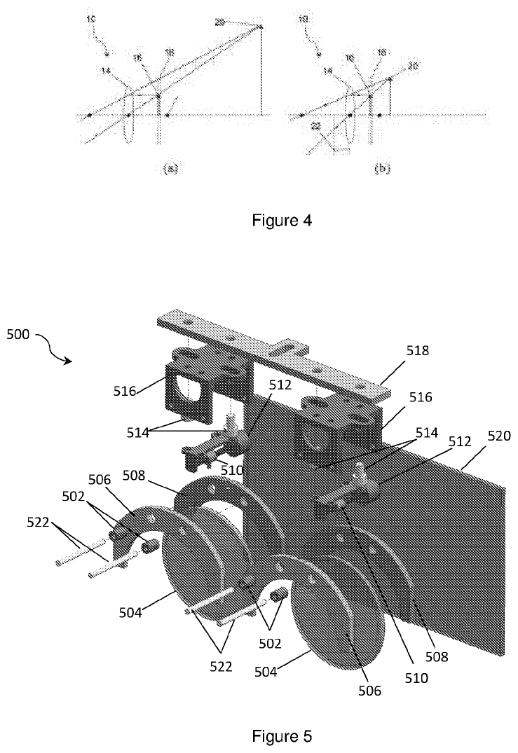

FIG. 4 is an optical ray diagram 10 which describes the basic principle of optical magnification of an object, when viewed through an optical system. When an object shown on the display 18 is placed within the focal length of a convex lens 14, the virtual image 20 is located at a larger distance than the distance of the real object 16 as seen in FIG. 4(a). When the lens 14 or the display 18 is moved closer with respect to the other, the size and position of the virtual image 20 varies. FIG. 4(b) shows the effect of moving lens 14 closer to the display 18 through translation 22: the size of the virtual image 20 and its distance to the lens decrease; conversely, they increase when lens 14 is moved further away from the display 18. The size of the virtual image 20 also changes depending on the focal length of the lens 14.

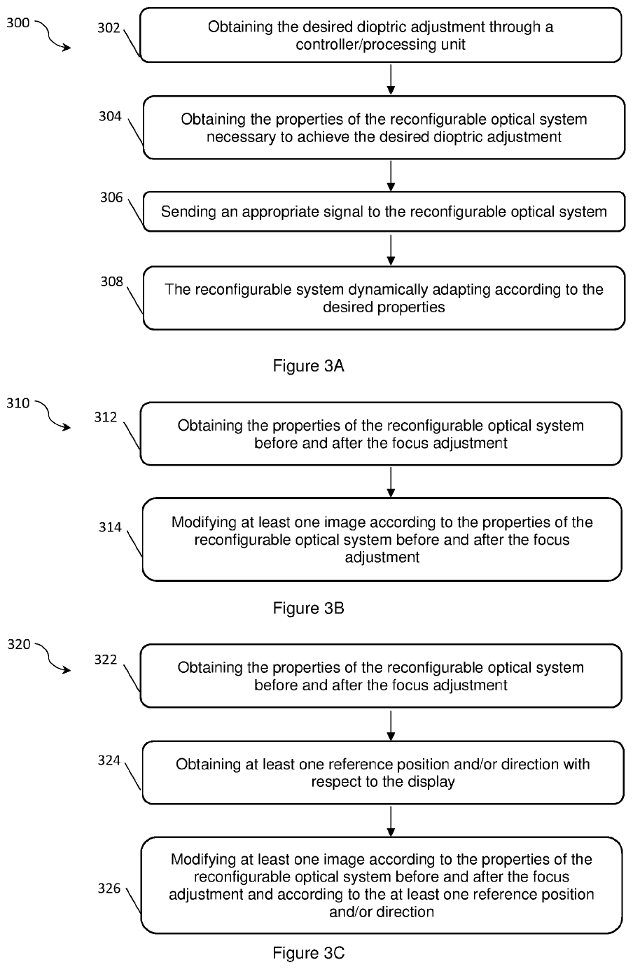

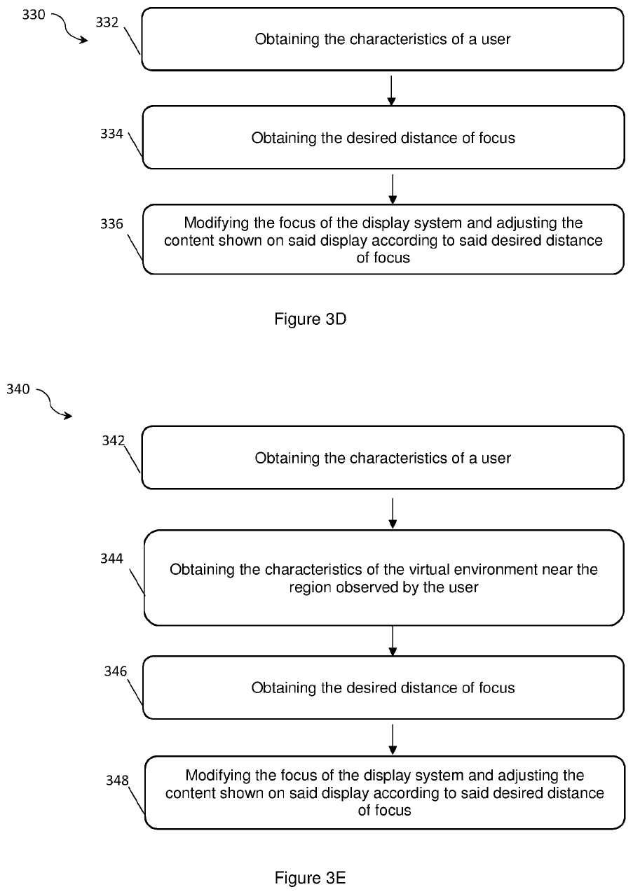

Thus, embodiments of the present application provide a method adjusting the focus of a display system. FIG. 3A illustrates an embodiment of the method 300 for adjusting the focus of a display system.

As shown, the method 300 comprises the following steps:
Step 302: obtaining the desired dioptric adjustment through the controller/processing unit;
Step 304: obtaining the properties of the reconfigurable optical system necessary to achieve the desired dioptric adjustment;
Step 306: sending an appropriate signal to the reconfigurable optical system;

and
Step 308: the reconfigurable system dynamically adapting according to the desired properties.

The properties in step 304 may comprise determining the focal length of an optical system, the position of an optical system, the position of an electronic display, or a combination of the same, in order to achieve the optimal focus for the viewer.

The electronic display may have a planar shape, a curved shape, other geometrical shapes, or comprise a plurality of elements with such shapes. Moreover, it may comprise multiple stacked layers resulting in a volumetric display or a light field display enabling focus cues within a range. The following description focuses on planar two-dimensional displays which are commonly found, for example in LCD or OLED displays found in consumer smartphones. Other types of displays could be handled following the same principles described here, as will be understood by those skilled in the art. The display screen may be local or remote.

The reconfigurable optical system may use an actuated lens, focus tunable lens, liquid crystal (LC) lens, birefringent lens, spatial light modulator (SLM), mirror, curved mirror, or any plurality or a combination of the said components. An actuated lens system works on the principle of optical magnification, as described with respect to FIG. 3. A tunable lens has a deformable membrane which changes its shape; a LC lens changes the refraction of the liquid on applying a potential whereas a birefringent lens offers a different refractive index to the light with different polarization and propagation direction. A birefringent lens may be used in combination with a set of polarization system which may include SLM.

In some embodiments, the optical system may consist of a single lens or a compound lens system.

In some embodiments, the optical system comprises a lens system which is adjusted by an actuator. The actuator may be in the form of a stepping motor based on electromagnetic, piezoelectric or ultrasonic techniques.

In some embodiments, the reconfigurable optical system may include a lens barrel with at least one mechanism to variably alter the light path when the light rays pass through the barrel. The said barrel is essentially an eyepiece for the viewer to look through on to an electronic display with varying optical path lengths.

In some embodiments, a sensor or a set of sensors is employed to determine the precise location of moving components. The sensor may be based on a mechanical, electrical, optical or magnetic sensor, or a combination of them. The purpose of the sensor is to provide feedback to the controller or processing unit to determine the current status of the reconfigurable optical system and send appropriate signals. Alternatively, the initial position of all the components can be determined by defining a home position. The variable components can be set to their home position for calibration at any time.

In some embodiments, part of the electronic display may be in focus. The entire display may not necessarily be entirely in focus.

In some embodiments, a controller or a processing unit may be employed to operate the reconfiguration of the optical system.

### Image Adjustment on the Display

The adjustment of the display system according to another embodiment of the invention described above may affect the size and aspect of an image shown on the display viewed through the optical system. In some embodiments, a change in focal length or in position of the optical system results in a variation of magnification. Furthermore, the lateral position of an image shown on the display viewed through the optical system may change when the dioptric adjustment of the optical system varies and the observer position is not aligned with the optical axis of the system. This may cause discomfort for users when the focus of the display system is adjusted dynamically and thus may interfere with the ability to clearly see the display viewed through the optical system.

In accordance with another embodiment of the present application, there is provided a method for adjusting the content shown on a display according to a focus adjustment of a display system. As illustrated in FIG. 3B, a method 310 for adjusting the content shown on a display according to a focus adjustment of a display system comprises steps including:
Step 312: obtaining the properties of the reconfigurable optical system before and after the focus adjustment; and
Step 314: modifying at least one image according to the properties of the reconfigurable optical system before and after the focus adjustment.

The image modification in step 314 may comprise accounting for geometric or colour distortion when viewing the display through the optical system, as such distortion may vary due to the focus adjustment of the display system.

The modified image or images may be transmitted, saved, and/or shown on the display following step 314.

In accordance with another embodiment of the present application, there is provided a method 320 for adjusting the content shown on a display according to a focus adjustment of a display system, such that the size and position of the image perceived from a specific position remain substantially the same after focus adjustment. In other words, images captured by a camera placed at said specific position would remain substantially similar in size and position, when observed from a specific position. For example, the camera may be a pinhole camera. Advantageously, a user whose eye would be located at said position would not perceive a substantial variation in the image before said user's eye starts accommodating as a result of the focus change. As shown in FIG. 3C, the method 320 comprises steps including:
Step 322: obtaining the properties of the reconfigurable optical system before and after the focus adjustment;
Step 324: obtaining at least one reference position and/or direction with respect to the display; and
Step 326: modifying at least one image according to the properties of the reconfigurable optical system before and after the focus adjustment and according to the at least one reference position and/or direction.

As described above, a goal of various embodiments of the present application is to make the user's eye accommodate when viewing through a display system by creating focus cues. This goal seeks to create retinal images similar to those what would be perceived in the real world.

One method of making the user's eye accommodate is to adjust the adaptive optics in the optical system. Moving the focus distance of the optical system to a distance corresponding to the observed virtual object creates retinal blur and encourages the eye to accommodate and reduce the vergence-accommodation conflict.

However, this method has drawbacks such as the perceived magnification (i.e. size) or position of the image observed through the optical system may change, and distortions may appear, which may cause discomfort and cause the virtual environment to appear less realistic.

In addition, a limitation of a display system with a single plane of focus, even if said focus is modified as described above, is that the image may be perceived as uniformly sharp when the user accommodates to said plane of focus. In contrast, most images in the real world captured by a real eye contain non-uniformly blurred regions, due to depth-dependent retinal blur.

Various embodiments of the present application provide varifocal distortion correction to overcome the above mentioned drawbacks brought about by the change in image size, image position, or distortions during focus adjustment of the optical system, and to overcome to above mentioned limitation of the display system with a single plane of focus which results in the perceived image having a uniform sharpness.

In one embodiment, the displayed image is modified to create depth-of-field blur in regions of the image corresponding to objects at distances different from the current focus. A computer-implemented depth-of-field blur method may take as input the rendered image, scene and/or image depth, the current accommodation state of the user and the current focus of the optical system. The software implementation may use depth-dependent disc filters to blur the image, or other algorithms as understood by those skilled in the art.

In another embodiment, the displayed image is modified to create a retinal image substantially similar to the retinal images that would be observed if the virtual environment was observed in the real world. A computer-implemented artificial retinal blur may take as input the rendered image, scene and/or image depth, the current accommodation state of the user and the current focus of the optical system. The software implementation may use simulations of eye models, including by taking into account chromatic aberrations in the eye such as longitudinal chromatic aberrations. Such simulations may be conducted using raytracing, as will be understood by those skilled in the art, and the eye model parameters may depend on the characteristics of the user.

In some embodiments, the modification of the image to create depth-of-field or retinal blur may take place substantially simultaneously with the adjustment of the focus of the optical system. Advantageously, this may induce an initial accommodative response in the user's eye and decrease the perceived latency of the adjustment of the adaptive optical system. Another advantage is that it may increase the perception of realism for the user.

In some embodiments, the reference positions and/or directions in step 324 are used to evaluate certain properties of the display when viewed through the optical system from the reference positions and/or directions. In one embodiment, the reference position would be on the optical axis of an eyepiece of a head-mounted display, at a distance corresponding to the eye relief of the user. Said properties may include the size, aspect, apparent resolution, and other properties, of images shown on the display and viewed through the optical system. In some embodiments, said properties are evaluated through simulation, including computer-based raytracing simulations taking into account the reference positions and/or directions, the geometry and/or materials of the display system, and/or digital images shown on the screen. Said geometry and materials may be fixed, precalculated, or dynamically estimated and obtained by a controller or a processing unit. Moreover, such simulations in some embodiments facilitate the calculation of inverse image transformations used to compensate for the distortion of the display viewed through the optical system from a reference position and/or orientation. Advantageously, these embodiments allow detecting that the user's eye is not aligned with the optical system, and correct the distortion accordingly.

In some embodiments, modified images in step 326 are produced by applying image transformations derived from such simulations. Applying such transformations can be performed efficiently through a pixel-based or mesh-based image warp, as will be understood by those skilled in the art.

Notably, the combined focus adjustment of the display system and image adjustment on the display enables compensating for the changes in apparent size, aspect, and/or position, of images shown on the display and viewed through the optical system from a reference position. In some embodiments, the display focus adjustment and the image adjustment are conducted substantially simultaneously. Advantageously, the apparent size, aspect, and/or position, of images shown on the display and viewed through the optical system from a reference position thus remain substantially the same despite the adjustment in focus.

The reference positions and/or orientations in step 324 may be fixed, precalculated, or dynamically estimated and obtained by one or more controllers or processing units. In some embodiments, an eye tracker is used to detect the position of a user's eye and the user's gaze direction.

The modified image or images may be transmitted, saved, and/or shown on the display following step 326.

Notably, the reference positions and/or directions do not require to be aligned with the optical axis of the optical system, when such an optical axis exists, as is the case with spherical lenses. It should be understood that off-axis reference position and oblique reference directions often lead to significant distortions in such optical systems. Embodiments of the present application can handle such cases.

In some embodiments, a controller or a processing unit may be employed to operate the simultaneous modification of dioptric setting and image adjustment, or send signals to a separate processing unit.

### Focus Adjustment Depending on Content and User

In accordance with another embodiment of the present application, there is provided a method 330 for adjusting the focus of a display system and adjusting the content shown on said display according to the characteristics of a user. As shown in FIG. 3D, the method 330 comprises steps including:
Step 332: obtaining the characteristics of a user;
Step 334: obtaining the desired distance of focus; and
Step 336: modifying the focus of the display system and adjusting the content shown on said display according to said desired distance of focus.

The characteristics of a user obtained in step 332 may include characteristics related to the user's eye positions, eye orientations, and/or gaze direction. In some embodiments, a Point of Regard may be derived from measurements of the eye vergence, said point approximating the three-dimensional position of the object being observed in the virtual environment. Moreover, such characteristics may include the position of the user with respect to the display system, and/or the distance and/or the lateral position from the user's eyes to the display system. Furthermore, said characteristics may include the user's eyeglasses prescription, including the degree of myopia and hyperopia in each eye.

In some embodiments, an eye tracking device may be used to obtain characteristics of a user, such as the eye positions and directions. Said eye tracking device may include at least one infrared (IR) camera, at least one IR LED, and at least one hot mirror to deviate light in the IR range and let visible light pass through.

In some embodiments, proximity sensors and/or motion sensors may be used in order to obtain the position of the user.

In some embodiments, the eyeglasses prescription of a user is measured electronically or is provided before the use of an embodiment of this invention. It may be measured with an embedded or external device which transmits the information to an embodiment of the invention.

In some embodiments, characteristics of the user may be loaded from a memory or saved to a memory for later reuse.

In some embodiments, the desired distance of focus in step 334 is set to the distance between the three-dimensional point being observed by the user in the virtual environment and the three-dimensional point corresponding to the position of said user in the virtual environment.

Moreover, in some embodiments, the desired distance of focus obtained in step 334 may be modified in order to take into account the refractive error of the user when adjusting the focus dynamically. With the amount of myopia or hyperopia M is expressed in diopters, the desired distance of focus is obtained by substracting 1/M meters for myopia, or by adding 1/M meters for hyperopia. A similar principle may be used to handle presbyopia, and/or astigmatism if the focus-adjustable optical system supports varying focus across different meridians.

In accordance with yet another embodiment of the present application, there is provided a method 340 for adjusting the focus of a display system and adjusting the content shown on said display according to the characteristics of a user and visual content displayed. As shown in FIG. 3E, the method 340 comprises steps including:
Step 342: obtaining the characteristics of a user;
Step 344: obtaining the characteristics of the virtual environment near the region observed by the user;
Step 346: obtaining the desired distance of focus; and
Step 348: modifying the focus of the display system and adjusting the content shown on said display according to said desired distance of focus.

The characteristics of the virtual environment obtained in step 344 may include the three-dimensional geometry, the surface materials and properties, the lighting information, and/or semantic information pertaining to the region observed by the user in the virtual environment. Such characteristics may be obtained in the case of a computer-generated three-dimensional virtual environment by querying the rendering engine, as will be understood by those skilled in the art. Moreover, an image or video analysis process may extract characteristics from the visual content shown on the display.

In some embodiments, such characteristics are used to identify the position of the three-dimensional point being observed by the user in the virtual environment. In particular, when certain characteristics of the user are obtained through eye tracking, the geometry and other properties of the virtual environment may help in improving the precision and accuracy of the point of regard estimation. In some embodiments where the position and orientation of only one eye of the user can be obtained, the monocular point of regard may be estimated by calculating the intersection of the monocular gaze direction with the geometry of the virtual environment, for example using raytracing.

In some embodiments, the desired distance of focus obtained in step 346 is pre-defined before the use of an embodiment of the invention. It is loaded substantially at the same time as or before the visual content is shown on the display. One application relates to digital storytelling and the ability to stir the user's gaze toward specific regions of the scene at certain times.

### Use in Stereoscopic Displays and HMDs

In accordance with yet another embodiment of the present application, there is provided a system for the use of focus and image adjustment methods for stereoscopic displays and head mounted displays (HMDs). The system comprises at least one electronic display showing stereoscopic images; at least one reconfigurable optical system per eye, where the image viewed by each eye through the optical system appears at a distance substantially similar to the distance of a three-dimensional point observed in the virtual environment; and at least one controller or a processing unit.

The stereoscopic display in may be realized in multiple manners resulting in two independent images when viewed from left and right eye. Example realizations include physical separation, or polarized systems.

In some embodiments, an eye tracking system is integrated into the stereoscopic display and/or HMD to determine the direction of at least one eye. It may also include stereo eye tracking to obtain the binocular gaze direction of the user.

In some embodiments, an eye tracking system is combined with the reconfigurable optical system.

In some embodiments, a stereo eye tracking system is based on the eye vergence of the user to determine the depth of the object observed by the user.

In some embodiments, the focus adjustable display system and a stereo eye tracking are employed to minimize the vergence-accommodation conflict. Such a stereoscopic display or HMD may help reducing asthenopia and may allow the user to use the stereoscopic display or HMD for an extended period of time. One application of such stereoscopic displays and/or HMDs is to be used as a media theatre to watch a full-length movie. Another application is used in enterprise VR, especially for close object inspection, where there is a need for continuous use of headsets for extended periods.

Advantageously, the above methods and systems provide dynamic focus adjustment in HMDs that include stereoscopic displays for reducing the vergence-accommodation conflict which commonly causes visual discomfort when using HMDs for extended periods.

FIG. 5 shows an exploded view of a CAD diagram of one embodiment of the present application. In FIG. 5, a stereoscopic display system 500 comprises two independent eyepieces placed in front of an electronic display. For each eyepiece, a lens holder consisting of two parts, front 506 and back 508, grips the lens 504 between it. An ejector sleeve 502 is inserted into the lens holder. An ejector pin 522 passes through the sleeve such that the lens holder, along with the lens 504, can slide over the pin. A linear slider 510 controls the sliding mechanism. The linear slider 510 is translated via the screw of a linear stepper motor 512. The stepper motor is mounted on the housing 516. The ejector pins 522 are also push fit in to the housing 516. A T-shape support plate 518 connects the housings 516 via screws 514. An LCD display 520 is also connected to the support plate 518 (attachment not shown here). The purpose of the motorized assembly is to allow the lens to move smoothly in a direction substantially orthogonal to the electronic display 520, thus enabling focus adjustment of the display system 500. At least one controller or a processing unit (not shown) controls the image shown on the display, and determines the actuation of the motors and thus the position of the lenses. The controller/processing unit sends an appropriate signal to the motors via at least one motor driver which ensures the motor is moved to the determined location.

In the display system 500, the appropriate position of each lens 504 is determined by a controller/processing unit (not shown) through precalculated ray tracing simulations, in order to make the virtual image appear at a specific depth, when viewed through the said lens 504 from at least one reference position.

Given at least one reference position and/or direction and a position of a lens 504, images shown on display 520 are modified such that certain properties of said images remain substantially constant when viewed through said lens 504 from the reference position and/or direction. Said properties may include size, aspect, apparent resolution, and other properties. Advantageously, the images shown on display 520 may be modified such that their apparent size, aspect, and/or position, when viewed through a lens 504 remain substantially the same despite the adjustment in focus.

The display system 500 enables the focus adjustment of the display system at essentially high speeds. The display focus adjustment and the image adjustment are thus conducted substantially simultaneously. Advantageously, the apparent size, aspect, and/or position, of images shown on the display and viewed through a lens 504 from a reference position and/or direction thus remain substantially the same despite the rapid adjustment in focus.

Different variations of the above-mentioned embodiments may be implemented by using tunable lens, LC lens, SLM, mirrors, curved mirrors, and/or birefringent lens. The display system may also use one display screen for both eyes, one display screen for each eye or multiple display screens per eye.

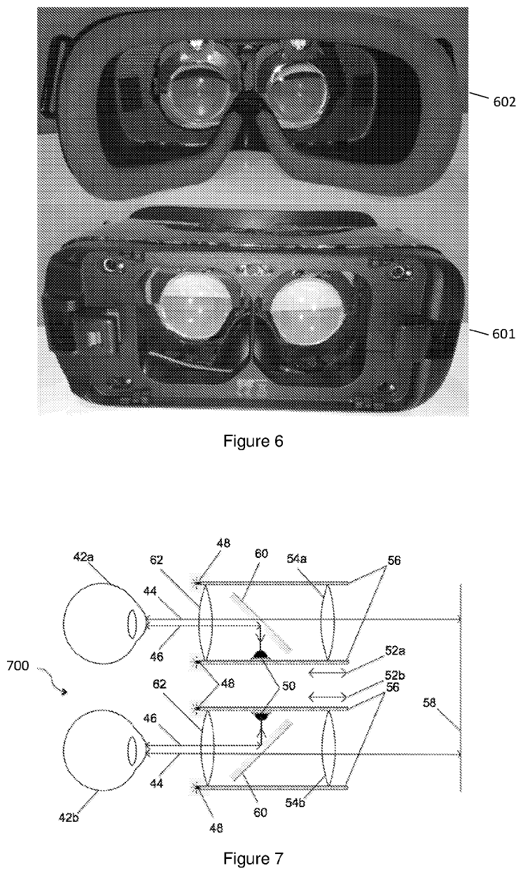

In accordance with the above described methods and systems, a commercial HMD (Samsung GearVR 2016) is modified to enable substantially simultaneous focus adjustment and image adjustment. FIG. 6 shows a photograph of the stereoscopic display system 500 in use inside the HMD, where the electronic display 520 and controller/processing unit are embedded in a smartphone (not shown) inserted into the HMD. Table 1 lists the necessary position of lens 504 with respect to the electronic display 520 and to the eye, for one given position of the eye (52.32 mm from the display), obtained through raytracing. This embodiment enables a range of focal adjustment between +1 D to −7.5 D dioptres. Said range could be extended through the use of different translation ranges of lens 504, different headset sizes, or different lenses.

TABLE 1
Focus adjustment of the display system

| Focus Adjustment | Eye-lens distance | Lens-screen distance |
|---|---|---|
| [D] | [mm] | [mm] |
| 1 | 16.52 | 35.8 |
| 0.5 | 17.27 | 35.05 |
| 0 | 18.02 | 34.3 |
| −0.5 | 18.77 | 33.55 |
| −1 | 19.52 | 32.8 |
| −1.5 | 20.27 | 32.05 |
| −2 | 21.02 | 31.3 |
| −2.5 | 21.77 | 30.55 |
| −3 | 22.52 | 29.8 |
| −3.5 | 23.27 | 29.05 |
| −4 | 24.02 | 28.3 |
| −4.5 | 24.77 | 27.55 |
| −5 | 25.52 | 26.8 |
| −5.5 | 26.27 | 26.05 |
| −6 | 27.02 | 25.3 |
| −6.6 | 27.77 | 24.55 |
| −7 | 28.52 | 23.8 |
| −7.5 | 29.27 | 23.05 |

In order to achieve image adjustment on the display for each position of the lens, one or more controllers and/or processing units synchronizing the adjustment of the image and the actuated lens system may be embedded in a computational device, for example a smartphone having the display. The controllers and/or processing units may be implemented in a number of ways, including implementing in a microprocessor, implementing in a host computer, or a combination thereof.

One embodiment, as depicted in FIG. 7, includes a stereoscopic display system 700 comprising a movable lens system integrated with an eye tracking system. The embodiment comprises lens barrels 56 containing lenses 62 which have a fixed position and lenses 54a, 54b which can be moved within the lens barrels 56. The moveable lenses 54a, 54b are translated along their optical axes using an actuator (not shown). Hot mirrors 60 are placed in between the fixed lenses 62 and moveable lenses 54a, 54b. The function of hot mirrors 60 is to let the visible light 44 pass through and reflect the infrared light 46 to the infrared cameras 50. The left eye 42a and the right eye 42b of a viewer are illuminated by infrared LEDs 48 mounted on the outer rings of the lens barrels 56. The infrared LEDs 48 do not obstruct the normal viewing of the display system by the viewer. The viewer sees the visible light coming from the LCD display 58 through lenses 54a, 54b, and 62, unobstructed by the hot mirror 60. The infrared cameras 50 capture infrared images of the corneas of the viewer illuminated by infrared light. The images of both left 42a and right 42b eyes captured by the camera are then fed to a controller or processing unit (not shown), which determines the binocular gaze of the viewer through an eye tracking algorithm.

The lenses 62 ahead of the hot mirrors 60 do not move when the focus of display system 700 is adjusted. This is advantageous because it does not cause distortion in the eye images captured by cameras 50 when the focus of display system 700 changes.

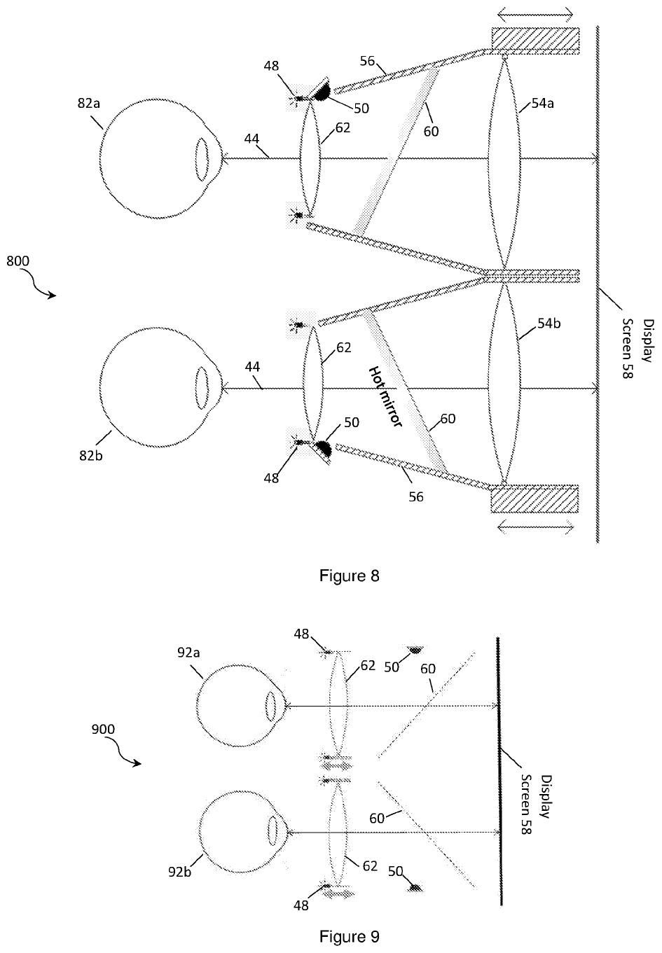

FIG. 8 shows a schematic diagram 800 of a focus adjustable stereoscopic display system integrated with an eye tracking system in accordance with another embodiment of the present application.

The focus adjustable stereoscopic display system 800 is similar to that shown in FIG. 7, except that the focus adjustable stereoscopic display system 800 ensures a constant field of view (FOV) similar to the lens closer to the user's eyes.

FIG. 9 shows a schematic diagram 900 of a focus adjustable stereoscopic display system integrated with an eye tracking system in accordance with yet another embodiment of the present application.

The schematic diagram 900 includes a stereoscopic display system that comprises an adjustable optical system and a robust eye tracking system wherein the infrared camera is located between the moveable lens 62 and the display system 58. The moveable lenses 62 may be translated along their optical axes using a micro stepping motor. A plurality of infrared (IR) lights 48 placed around the lenses 62 illuminate the user's eyes and create bright reflections on the cornea that can be captured by IR cameras. The infrared light 48 does not obstruct the normal viewing of the display system 58 by the viewer. Two hot mirrors 60 are placed between the adjustable lenses 62 and the display 58 to deviate light in the IR range and let visible light pass through. A pair of IR cameras 50 are placed between the adjustable lens 62 and the display 58, in such a way that they capture IR images of the eye 92A, 92B observed through the moveable lens 62. The eye tracking cameras 50 and hot mirror 60 cannot be seen in visible light from the position of the eye 92A, 92B. It will be understood by those skilled in the art that the moveable lenses 62, which may be interchangeably referred to as an adjustable optical system 62, may be of any adaptive optics type, such as moveable lenses, Alvarez lenses, liquid crystal lenses, Spatial Light Modulators (SLMs), electronically-tunable lenses, mirrors, curved mirrors, etc.

The focus adjustment of the adjustable optical system 62 may cause the images captured by IR cameras 50 to appear distorted with a changing magnification and/or aberrations, which may negatively affect the accuracy and/or precision of the eye tracking.

To address the negative impact caused by the focus adjustment of the adjustable optical system, a computer-implemented method is implemented in an embodiment of the present application to take as input the images captured by IR cameras 50 during the eye tracking and undistort the images based on the current focus of lens 62, which in one embodiment is provided by the adaptive optics controller as illustrated in FIG. 1B. Advantageously, the output is a pair of undistorted images whose size and shape would appear substantially similar when the focus of the adjustable optical system 62 changes. Said undistorted images are used as input to an eye tracking method, such as based on dark pupil tracking, bright pupil tracking, detection of Purkinje images, or glints. Advantageously, the use of a glint-based eye tracker may advantageously be more robust to defocus blur caused by the focus adjustment of 62 in the images captured by IR camera 50.

In one embodiment, the IR lights 48 may be independently turned on/off, or their brightness adjusted, to help identify bright reflections of the LEDs on the cornea.

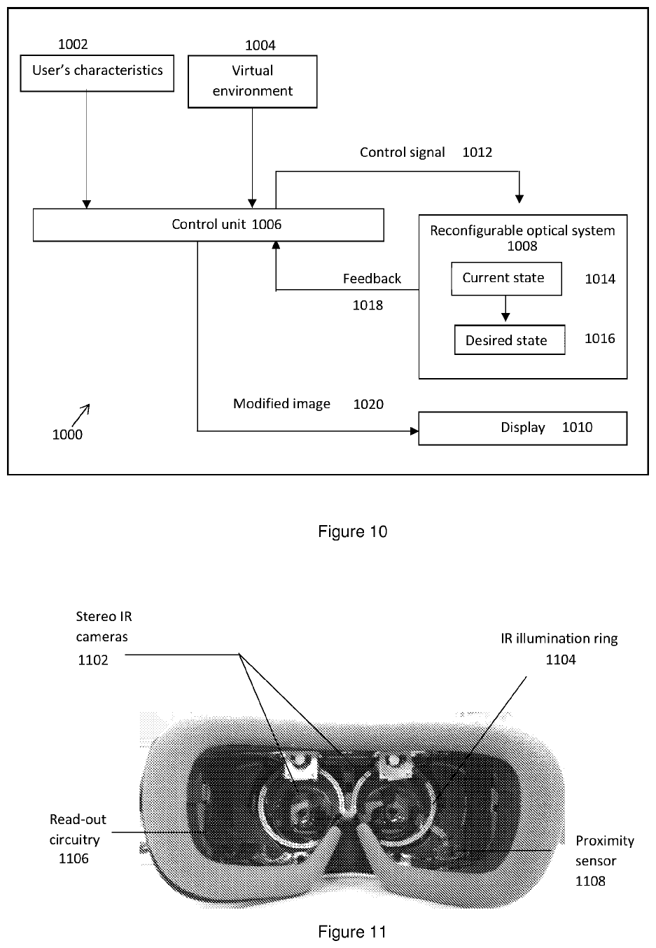

FIG. 10 illustrates a schematic of a system 1000 for viewing a virtual environment 1004 through an optical system 1008, which depicts how different parts of the system interact with each other. The system 1000 comprises the optical system 1008 configured to view the virtual environment 1004 on a display 1010; at least one processor; and at least one memory including computer program code. In the embodiment shown in FIG. 10, the at least one processor and at least one memory including computer program code are not shown, and are implemented in a control unit 1006, which is interchangeably referred to as a controller. The at least one memory and the computer program code are configured to, with at least one processor in the control unit 1006, cause the system 1000 at least to: determine a focus of the optical system 1008; instruct the optical system 1008 by a control signal 1012 to reconfigure in response to the determination of the focus of the optical system 1008; and optionally or additionally, instruct the display 1010 to show a modified rendering of the virtual environment in response to the reconfiguration of the optical system 1008. The reconfiguration of the optical system 1008 may be from a current state 1014 to a desired state 1016.

In the system 1000, the control unit 1006 determines the focus of the optical system 1008 by determining at least one gaze direction of the user when using the optical system 1008 to view the virtual environment 1004; and determining at least one point in the virtual environment 1004 corresponding to the gaze direction of the user. Additionally, in the system 1000, the control unit 1006 further determines the focus of the optical system 1008 in response to the received input of the user's characteristics 1002 and the virtual environment 1004. The user's characteristics 1002 include a characteristic of the user's eyesight, an eyeglasses prescription of the user, eyesight information of the user, demographic information of the user and a state of an eye condition of the user. The control unit 1006 determines the focus of the optical system so as to improve clarity of the viewing of the virtual environment 1004 or improve the comfort level of the user.

In the system 1000, the control unit 1006 instructs the display 1010 to show a modified image 1020 that compensates the reconfiguration of the optical system 1008 so that the size of the virtual environment 1004 that is perceived by the user remains unchanged. The instruction may be generated by the control unit 1006 in response to the received input as described above.

Alternatively or additionally, in the system 1000, the control unit 1006 causes the system 1000 at least to perform the at least one of the determination of the focus of the optical system 1008, the instruction of the optical system 1008 to reconfigure and the instruction of the display 1010 to modify the rendering of the virtual environment (e.g. by providing a modified image) in response to a receipt of at least one of a position of one of the user's eyes, a position of the user, a direction of the user's gaze and a characteristic of the user's eyes, wherein the characteristic of the user's eyes includes a distance between the user's eyes.

In the system 1000, the control unit 1006 causes the system 1000 at least to instruct the optical system 1008 to adjust at least one of a focal length of the optical system 1008, a position of the optical system 1008, a position of the display 1010 on which the virtual environment 1004 is rendered and a distance of the optical system 1008 relative to the display 1010 on which the virtual environment 1004 is rendered.

In the system 1000, the reconfiguration of the optical system 1008 induces an accommodation response in at least one of the user's eyes. In consequence to the reconfiguration, the optical system 1008 may also provide a feedback 1018 to the control unit 1006 to generate a closed-loop control of the optical system 1008. The feedback 1018 may also be used as an input to the varifocal distortion correction module.

In the system 1000, the virtual environment is in virtual reality or augmented reality or mixed reality or digital reality, or the like.

FIGS. 11 to 13 illustrate an embodiment of the present application in which cameras are mounted in the bottom of a HMD headset to form a compact eye tracking system.

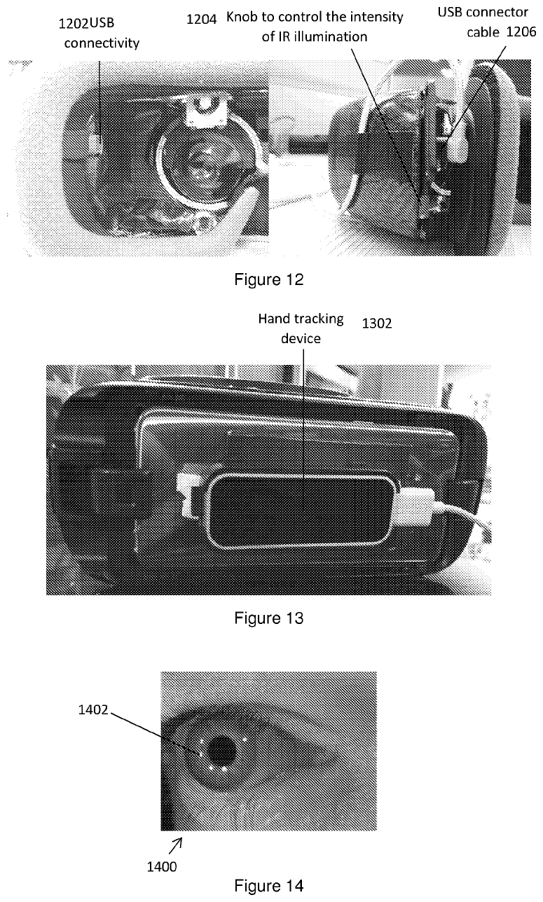

An embodiment depicted in FIGS. 11 and 12 includes a stereoscopic display system in a HMD comprising a movable lens system integrated with an eye tracking system as described above. The moveable lenses, as described above, are translated along their optical axes using a micro stepping motor. An infrared (IR) light illumination ring 1104 placed around the lenses, with multiple infrared LEDs, illuminates the user's eyes uniformly with the infrared light. The infrared light does not obstruct the normal viewing of the display system by the viewer. Two IR cameras 1102 are embedded at the bottom of the HMD and are placed below the IR ring 1104 to look at the user's eyes. The IR cameras 1102 capture infrared images of the corneas of the user illuminated by infrared light. The images of both left and right eyes are captured by the camera 1102, read by the read-out circuit 1106, and then fed to a controller (not shown) via USB connectivity 1002 by a USB controller cable 1006, which determines the binocular gaze of the viewer through an eye tracking algorithm. In addition, the display system may include a proximity sensor 1108 to obtain the position of the user, and a knob 1004 to control the intensity of the IR illustration.

Alternatively, the cameras of the eye tracking system can be embedded in the nose bridge of the HMD. Advantageously, the nose bridge placement allows adequate eye coverage, such that a broad range of the user's monocular or binocular gaze can be tracked.

In an embodiment of the compact eye tracking system for HMDs, eye tracking cameras 50 are embedded in the nose bridge of the HMD to track user's monocular or binocular gaze. Additionally, illumination sources, for example infrared LEDs 48, can also be embedded in the nose bridge of the HMD.

Alternatively, the compact eye tracking system can be implemented by eye tracking cameras 50 and illumination sources 48 embedded in the nose bridge of eyeglasses to track user's monocular or binocular gaze.

The above described eye tracking system may be in form of an eyepiece for monocular eye tracking or two eyepieces put together for binocular eye tracking.

The above described eye tracking system may comprise single or multiple cameras embedded in the nose bridge of the HMD to acquire coloured and infrared (IR) images of the user's eyes simultaneously and/or sequentially. In case of a single camera for both coloured and IR images, the camera includes a dynamically changeable light filter over the camera sensor. The changeable filter may comprise of a mechanically or electrically changeable or tunable light filter.

An example of an image 1400 of the right eye captured by a camera embedded in the nose bridge of the HMD, is shown in FIG. 14. As shown in the image 1400, the reflections 1402 on the cornea of the right eye of infrared (IR) LEDs placed on an IR illumination ring, similar to the IR illumination ring 1104, can be clearly seen by the nose bridge mounted camera.

FIG. 13 shows an embodiment in which a HMD having the compact eye tracking system as shown in FIG. 11 is integrated with a hand tracking device 1102. By virtue of the compact eye tracking system, this embodiment advantageously allows close inspection of objects in a virtual environment using hand manipulation with zero or minimal visual discomfort for the user. The user's hands act as controllers or inputs to interact with the objects in the virtual environment. In a virtual environment shown with this embodiment, users manipulate virtual objects with their hands and bring them to near distances for close object inspection. Advantageously, the focal plane in the head-mounted display is adjusted dynamically in accordance with the distance to the object observed, therefore reducing visual fatigue due to the vergence-accommodation conflict.

In view of the above, various embodiments of the present application provide methods and systems for viewing a virtual environment through an optical system. The methods and systems advantageously combine the dioptric adjustment of optical systems with the modification of images shown on displays, and may take into account the position and gaze direction of users, as well as the visual content shown on the display.

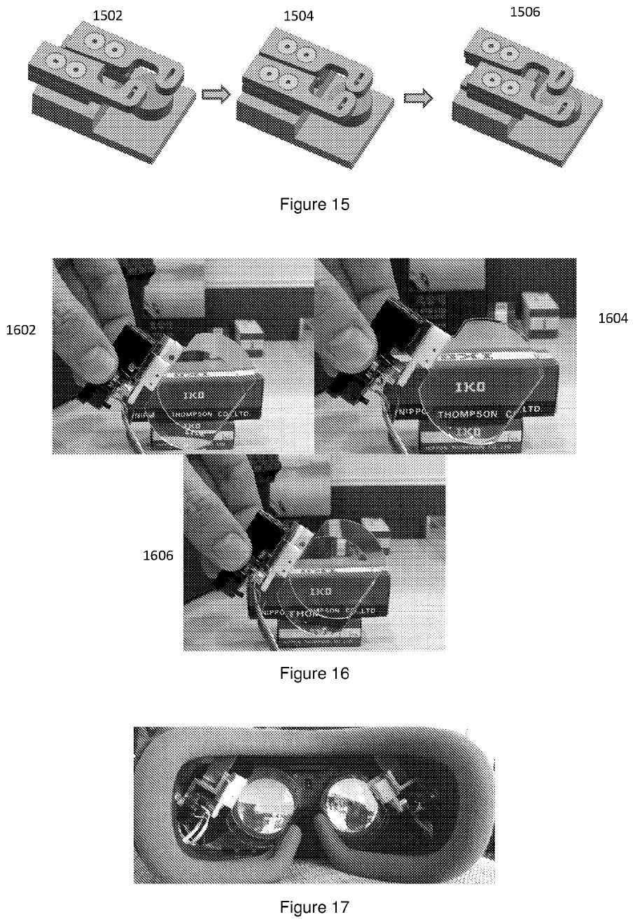

Advantageously, with respect to the dioptric adjustment of optical systems, FIGS. 15 to 18 depict a dynamic refocusing mechanism, which is a mechanism for achieving desired focusing power and/or vision correction so that users with eye refraction errors no longer need to wear eyeglasses to correct the eyesight when viewing the virtual environment, In this manner, a sharp and comfortable viewing experience is achieved without eyeglasses.

The dynamic refocusing mechanism uses a pair of Alvarez or Alvarez-like lenses that comprise at least two lens elements having special complementary surfaces (Alvarez lens pair) to provide wide range of focus correction and/or astigmatism correction within head-mounted displays (HMDs).

In various embodiments, the pair of Alvarez lenses or Alvarez-like lenses are used to correct for myopia, hyperopia and/or presbyopia in part or combination, by moving the lens elements laterally over each other. Astigmatism correction can also be achieved by adding another pair of Alvarez lenses and rotating it along the optical axis. The Alvarez lenses or Alvarez-like lenses can be placed either in front of the objective lens or behind the objective lens of the HMD. One advantage of placing the Alvarez lenses or Alvarez-like lenses behind the objective lens is that the user will not perceive the lens movement.

The pair of Alvarez lenses can be dynamically actuated using at least one actuator to achieve desired focusing power and/or vision correction. In some embodiments, the actuator generates opposing but equal in proportion motions for the at least two lens elements using a single actuator or motor in order to move two lenses (such as Alvarez-like lenses) over each other.

In some embodiments, the actuator can be a piezoelectric actuator (e.g. Thorlabs Elliptec™ X15G piezoelectric actuator). The piezoelectric actuator is a piezoelectric chip combined with a resonator or sonotrode, which acts like a cantilever, generates micro-level vibrations at the tip of the resonator. The resonator directly moves the driven element, usually made with plastic or similar materials, forward or backward because of friction. The driven element can be produced in many shapes, such as linear or circular to generate linear or circular motion profiles respectively. Such configuration of the piezoelectric actuator can be used to move the lens linearly or on a curvature or both without the need of any additional mechanism or control.

The actuation mechanism is based on electro-mechanical sliders which allow the lens elements to move over each other, thus achieving a focusing power approximating the focusing power of spherical or sphero-cylindrical lenses with a specific prescription of the user.

In some embodiments, the actuation mechanism uses rotary motion translated to linear motion, which allows the lens elements to move over each other thus achieving a focusing power approximating the focusing power of spherical lenses. In this manner, micro linear guides are used to maintain the distance between the lens elements and smooth motion of the lenses creating different focusing power. The linear motion is illustrated by three linear motion states 1502, 1504 and 1506 in FIG. 15 which indicate rotary motion being translated to linear motion that allows the lens elements to move over each other.

The amount of displacement and/or rotation of the lens elements may be calculated using raytracing simulations taking into account one or multiple of the following: distance from the lens elements to the two-dimensional display of the HMD, distance from the lens to the user's eyes, distance separating the complementary lens elements, indices of refraction of the lens elements, geometry of the lens element surfaces, position and/or orientation of each lens element, position and/or orientation of the user's eyes, refractive characteristics of the user's eyes, demographic information about the user.

The abovementioned dynamic refocusing mechanism can be used for focus correction of the users and/or solving accommodation conflict (VAC) in Virtual Reality (VR), Augmented Reality (AR), Mixed Reality (MR), or Digital Reality (DR) headsets.

In some examples, the Alvarez lenses can be placed along the user's nose in a Virtual Reality headset to maximize the available space. Each lens can be moved individually or in combination, linearly parallel and/or perpendicular to the nose, using electro-mechanical actuation system. A wide range of focus correction and/or astigmatism correction can thus be achieved.

As shown in FIG. 16, dioptric changes are achieved using the dynamic refocusing mechanism as shown in 1602, 1604 and 1606 of FIG. 16.

In an embodiment as depicted in FIG. 17, a HMD is provided with dynamic refocusing capability using Alvarez or Alvarez-like lenses. The lenses move along the user's nose so as not to be obstructed by the user's nose or face. The embodiment has the capability of providing individual focus correction for each eye or both eyes. It also helps solving vergence-accommodation conflict (VAC) inside the headset by providing accommodation cues consistent to the vergence cues. In this embodiment, a range of 0 to 3 dioptres can be achieved. It will be appreciated to those skilled in the art that the range may be variable. That is, a narrower or broader range may be achieved.

The abovementioned dynamic refocusing mechanism may be used in combination with a monocular or binocular gaze tracker.

The abovementioned dynamic refocusing mechanism may be used in combination with a rendering of the virtual environment in the HMD such that the size and position of the image perceived by the user does not substantially change during the refocusing due to the moving of the lens elements.

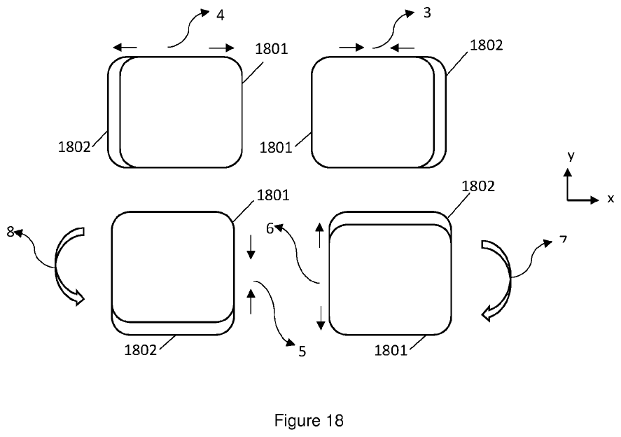

FIG. 18 shows different movements of Alvarez or Alvarez-like lens elements to create spherical power, create cylindrical power, or change cylinder axis, in accordance with various embodiments of the present application.

As shown in FIG. 18, two Alvarez or Alvarez-like lens elements 1801 and 1802 are configured to be moved laterally over each other in x-axis to create a positive or negative spherical power change. The lens element 1801 or 1802 can be translated separately or in combination towards each other, as in movement 3; or away from each other, as in movement 4.

Further, the two Alvarez or Alvarez-like lens elements 1801 and 1802 are configured to be moved laterally over each other in y-axis to create a positive or negative cylindrical power change. The lens element 1801 or 1802 can be translated separately or in combination towards each other, as in movement 5; or away from each other, as in movement 6.

In addition, the two Alvarez or Alvarez-like lens elements 1801 and 1802 are configured to be rotated in clockwise direction, as in movement 7; or counter-clockwise direction, as in movement 8, to change the cylinder axis. The lens element 1 or 2 can be rotated separately or in combination.

Advantageously, the spherical power change achieved by the movements of the two Alvarez or Alvarez-like lens elements 1801 helps in correcting refractive error including myopia, hyperopia, presbyopia and for dynamic refocusing to resolve vergence-accommodation conflict. Likewise, the cylindrical power change and the change in cylinder axis advantageously help in correcting astigmatism of a user.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects illustrative and not restrictive.

1-120. (canceled)

121. A system for viewing a virtual environment, the system comprising:
a display;
an optical system through which a user can view a rendering of the virtual environment on the display; and
a processing means coupled to the optical system and the display, the processing means determining a focus of the optical system, instructing the optical system to reconfigure in response to the determination of the focus of the optical system, and instructing the display to show a modified rendering of the virtual environment in response to the reconfiguring of the optical system, the modified rendering of the virtual environment correcting distortion in a user's viewing of the virtual environment introduced by reconfiguring the optical system.

122. The system in accordance with claim 121, wherein the processing means determines the focus of the optical system in response to determining a depth within the user's viewing of the virtual environment where the user is looking.

123. The system in accordance with claim 122 further comprising an eye tracking means for tracking at least one eye of a user viewing the rendering of the virtual environment on the display, wherein the eye tracking means is coupled to the processing means, and wherein the processing means determines at least one gaze direction of the eye of the user when using the optical system to view the virtual environment in response to information received from the eye tracking means, and wherein the processing means further determines the depth of at least one point in the virtual environment corresponding to the gaze direction of the user to determine the depth within the user's viewing of the virtual environment where the user is looking.

124. The system in accordance with claim 123, wherein the eye tracking means comprises a camera for capturing image information of at least one of the user's eyes, and wherein the processing means is coupled to the camera to receive the image information of the one of the user's eyes and correct the distortion in the user's viewing of the virtual environment by modifying the rendering of the virtual environment in response to the position of the one of the user's eyes as indicated by the image information of the one of the user's eyes.

125. The system in accordance claim 121, wherein the processing means corrects distortion in the user's viewing of the virtual environment by modifying the rendering of the virtual environment in response to the reconfiguring of the optical system such that a size, a position and/or distortion of a perceived image of the virtual environment remains unchanged before and after the reconfiguration of the optical system.

126. The system in accordance with claim 121 further comprising an input means coupled to the processing means, wherein the processing means further instructs the optical system to reconfigure in response to information including at least one of a characteristic of the user's eyesight, an eyeglasses prescription of the user, eyesight information of the user, demographic information of the user or a state of an eye condition of the user received from the input means.

127. The system in accordance with claim 126, wherein when the processing means further determines the focus of the optical system in response to the user input, the processing means determines the focus of the optical system in response to the user input to improve clarity of the viewing of the virtual environment on the display by the user and/or to improve a comfort level of the user when viewing the virtual environment on the display.

128. The system in accordance with claim 125, wherein the perceived image comprises an image perceived from at least one specific position, the image including one or more of an image perceived by an eye of the user, a computer-generated simulation generated by the processing means, or an image or video captured by a camera.

129. The system in accordance with claim 128, wherein the computer-generated simulation uses data from a simulated eye model or from a simulated camera to generate the image perceived from the specific position and/or uses raytracing to generate the image perceived from the specific position.

130. The system in accordance with claim 121, wherein the processing means modifies a the rendering of the virtual environment in response to the reconfiguring of the optical system in order to make the retinal image created by a viewing of the virtual environment through the optical system substantially similar to a retinal image that would be created if the virtual environment was observed in the real world.

131. The system in accordance with claim 130, wherein the processing means modifies the virtual environment in response to the reconfiguring of the optical system using computer-implemented depth-of-field blur to create depth-of-field blur in one or more regions of the perceived image of the virtual environment.

132. The system in accordance with claim 130, wherein the processing means modifies the virtual environment in response to the reconfiguring of the optical system using computer simulations of eye models which take into account characteristics of the eye of the use, wherein the characteristics of the eye of the user include myopia, hyperopia, presbyopia or astigmatism.

133. The system in accordance with claim 130, wherein the processing means modifies the virtual environment in response to the reconfiguring of the optical system using computer simulations of eye models which take into account chromatic aberrations in the eye of the user.

134. The system in accordance with claim 121, wherein the processing means either determines the focus of the optical system, instructs the optical system to reconfigure or instructs the display to modify the rendering of the virtual environment in response to receiving from the eye tracking means at least one of a position of one of the user's eyes, a position of the user, a direction of the user's gaze or a parameter of the user's eyes, wherein the parameter of the user's eyes includes a distance between the user's eyes.

135. The system in accordance with claim 121, wherein the processing means instructs the optical system to reconfigure by instructing the optical system to adjust at least one of a focal length of the optical system, a position of the optical system, a position of the display on which the virtual environment is rendered or a distance of the optical system relative to the display.

136. The system in accordance with claim 121, wherein the processing means instructs the optical system to reconfigure further in response the processing means determining a reconfiguration of the optical system which induces an accommodating response in at least one of the user's eyes.

137. The system in accordance with claim 131, wherein the optical system comprises a reconfigurable varifocal optical system and a controller for adjusting the reconfigurable varifocal optical system in response to the processing means instructing the reconfigurable varifocal optical system to reconfigure.

138. The system in accordance with claim 137, wherein the reconfigurable varifocal optical system comprises a plurality of elements, and wherein the controller of the optical system comprises:
a piezoelectric device;
a resonator device, the resonator device coupled to the piezoelectric device; and
a driven element, the driven element coupled to the resonator device and at least one of the plurality of elements of the reconfigurable varifocal optical system, wherein the piezoelectric device generates micro-level vibrations at a tip of the resonator to move the driven element, thereby moving the at least one of the plurality of elements of the reconfigurable varifocal optical system in a curvature.

139. The system in accordance with claim 138, wherein the micro-level vibrations at the tip of the resonator move the driven element in a manner such that the at least one of the plurality of elements of the reconfigurable varifocal optical system is further moved in a lateral motion.

140. A method for rendering a virtual environment, the method comprising:
reconfiguring an optical system through which the virtual environment is viewed; and
modifying the rendering of the virtual environment to compensate for the reconfiguration of the optical system in order to create a retinal image of a perceived image of the virtual environment substantially similar to a retinal image of the perceived image of the virtual environment that would be observed in an eye of the user if the virtual environment was observed in the real world.

141. The method in accordance with claim 140, wherein the step of modifying the rendering of the virtual environment comprises modifying the virtual environment in response to the reconfiguring of the optical system using computer-implemented depth-of-field blur to create depth-of-field blur in one or more regions of the perceived image of the virtual environment.

142. The method in accordance with claim 140, wherein the step of modifying the rendering of the virtual environment comprises modifying the virtual environment in response to the reconfiguring of the optical system using computer simulations of eye models which take into account chromatic aberrations in the eye of the user.

143. A computer readable medium comprising instructions for rendering a virtual environment on a display, the instructions configured to modify the rendering of the virtual environment to compensate for a reconfiguration of a varifocal optical system through which the virtual environment is viewed in order that a size, a position and/or distortion of a perceived image within the virtual environment remains substantially same before and after the reconfiguration of the varifocal optical system, the perceived image comprising an image perceived from a specific position, the image including one or more of an image perceived by an eye of the user, a computer-generated simulation, or an image or video captured by a camera.

144. The computer readable medium in accordance with claim 143, wherein the computer-generated simulation uses eye modeling or data from the camera to generate the image perceived from the specific position.

145. The computer readable medium in accordance with claim 143, wherein the computer-generated simulation uses raytracing to generate the image perceived from the specific position.
